(19) United States
(12) Patent Application Publication
(10) Pub. No.: US 2003/0221725 A1
(43) Pub. Date: Dec. 4, 2003

(54) Regenerative oxidizers with elliptical valve system

(76) Inventor: Richard Greco, Palm City, FL (US)

Correspondence Address: DYKEMA GOSSETT PLLC, 39577 WOODWARD AVENUE, SUITE 300, BLOOMFIELD HILLS, MI, 48304-5086, US

(21) Appl. No.: 10/157,349

(22) Filed: May 29, 2002

(51) Int. Cl. F16K 11/00

(52) U.S. Cl. 137/309

(57) ABSTRACT

A regenerative thermal oxidizer is provided, including a first heat exchanger defining a first flow path, a first inlet/outlet in association with the first heat exchanger, the first inlet/outlet providing flow access to the first flow path, a second heat exchanger defining a second flow path, a second inlet/outlet in association with the second heat exchanger, the second inlet/outlet providing flow access to the second flow path, a valve assembly having a cylindrical valve body having process flow inlet and outlet and first and second ports connected to the first and second inlet/outlet heat exchanger, and the valve assembly having an elliptical valve disk having an outer perimeter for sealably engaging the cylindrical body.

### FIELD OF THE INVENTION

The present invention relates generally to regenerative thermal oxidizers. More specifically, the present invention relates to valve systems for two chamber regenerative thermal oxidizers.

### BACKGROUND OF THE INVENTION

Regenerative thermal oxidizers (RTOs) are used in a number of industries to reduce the quantity of contaminants in process effluent gases. RTOs are unique in their ability to conserve fuel through the use of heat exchangers. In an RTO, the process effluent gases are oxidized in a combustion chamber. As the high-temperature combustion gases move to an exhaust stack, they flow through a heat exchanger, typically a chamber filled with ceramic saddles or the like. In the heat exchanger, up to 95% of the heat is transferred from the gases to the ceramic saddles. The flow of gases is then reversed such that the inlet process gases move through the heat exchanger toward the combustion chamber. Heat is transferred from the hot ceramic media to the process gases and consequently less energy is required to oxidize the process gases in the combustion chamber.

Several configurations of RTOs have been developed based on this heat recovery principle. In an RTO having three or more chambers, one heat exchanger sequentially serves as a standby chamber such that the continuous flow of process gas is not interrupted during flow reversal. In a two chamber RTO, however, neither of the heat exchangers can function as a standby chamber and thus the problem of handling a continuous process gas stream is more difficult. In a two chamber RTO both heat exchangers are separately attached to a shared combustion chamber. A flow path is thereby established that extends from the inlet of one heat exchanger, through the heat exchange medium, into the combustion chamber and then out via the second heat exchange chamber.

In order for the incoming process gas to capture heat from the heat exchangers, gas flow through the RTO must be periodically reversed. And, as will be appreciated by those skilled in the art, flow reversal must occur in a manner which minimizes discharge of unoxidized process gas to the atmosphere.

The prior art has used electronic and hydraulic controls to actuate valves in RTOs. It is difficult, however, to properly time the opening and closing of the valves associated with the heat exchange chambers and still maintain steady inlet pressures. Further, hydraulically opened and closed valves tend to significantly restrict the flow of gas through the valves when they first begin to close, but then slowly taper to zero. Accordingly, the valves are restricted in a manner which results in low flow percentages for a relatively long portion of the cycle.

Various types of cams and other mechanical actuation systems have also been used to open and close inlet and outlet butterfly/wafer valves in three chamber RTOs. These include mechanically operated means which have utilized eccentrically mounted secondary shafts driven by a main shaft.

In the case of two chamber RTOs the most frequently used valve system employs poppet valves actuated by hydraulic or air linear actuators connected to the valve shaft. Poppet valves go from zero flow to full flow quickly and the opening and closing of the poppets minimizes the tendency of foreign particles carried by the gases to be trapped in the valve. Gas moving through the valve is directed by the position of a disk or “poppet” which is fixed on a stem. The disk is moved linearly so that it seals one of two opposed valve seats.

In two chamber RTOs, two poppet valves are employed, each having its own hydraulic or pneumatic linear actuator. It will be appreciated that for efficient operation, both poppet valves must be timed so that they open and close as fast as possible, forming substantially airtight seals. While hydraulic or air linear actuated poppet valves have some advantages (i.e., the overall simplicity of poppet valves), for large RTOs such systems are not always reliable. For example, in a large RTO a poppet disk may weigh in excess of 300 pounds and may cycle 200,000 times per year. With disks of this size, poppet valves actuated hydraulically or by air linear means are inadequate to provide control and sealing force to the degree required for reliable operation. Moreover, due to the force with which the valves are closed, they may cause premature wear of valve seats, i.e. due to the “slamming” of the disk against the valve seat. Moreover, the lack of constant air pressure in RTOs, the temperature variability of many hydraulic fluids, as speed varies season to season due to ambient variances and occasional frozen air lines, and a number of other factors make these conventional systems less than optimum.

Therefore it would be desirable to provide a two chamber RTO valve system which addresses the problems inherent in the prior art. A two chamber RTO having a valve system which meets the above-noted objectives is described in Greco, U.S. Pat. No. 6,039,927. It is desirable to bring forth a two chamber RTO having a valve system which takes the improvements brought forth by Greco to a higher level. The present invention meets these objectives.

### SUMMARY OF THE INVENTION

In one aspect the present invention provides a first heat exchanger defining a first flow path. A first inlet/outlet in association with the first flow path is provided with the first inlet/outlet providing flow access to the first flow path. In like manner, a second heat exchanger defining a second flow path is provided. The second heat exchanger is associated with a second inlet/outlet. Additionally, a valve assembly is provided having a valve body having process flow inlet and outlets and first and second ports connected to the first and second inlet/outlets of the heat exchanger.

The valve assembly has an elliptical valve disk having an outer perimeter for sealably engaging the cylindrical body. The valve disk is pivotally mounted within the valve body having a first position connecting the process flow inlet with the first side port and process flow outlet with the second side port. In a second position, the disk connects the process flow outlet with the first port and a process flow inlet with the second port. Accordingly, only a single valve disk is required, unlike many prior RTOs which required separate valve disks.

In another aspect, a valve disk is provided which has a pivotal axis at an angle with its plane of extension. The valve disk seals directly against an interior surface of the valve body and can be rotated unidirectionally or bidirectionally.

Further aspects, features and advantages of the present invention will become more apparent to those skilled in the art after a review of the invention as it shown in the accompanying drawings and detailed description.

### BRIEF DESCRIPTION OF THE DRAWINGS

FIG. 1 diagrammatically illustrates the components and operation of the present invention.

FIG. 2 is a partial sectional view illustrating a disk sealably engaged with a valve body in the RTO shown in FIG. 1.

FIG. 3 is a diagrammatic illustration of the present invention in another embodiment in which the valve disk is pivotally mounted within the valve body at an angle with respect to a plane extension of the valve disk and wherein the valve disk is driven unidirectionally.

FIG. 4 is a partial sectional view of the RTO almost identical to that shown in FIG. 3 with a motor and linkage arrangement to give reciprocating motion to the valve disk.

FIGS. 5-7 are views taken along lines 5-5, 6-6, and 7-7 of FIG. 4, respectively.

FIG. 8 is a view taken along lines 8-8 of FIG. 7.

### DETAILED DESCRIPTION OF THE INVENTION

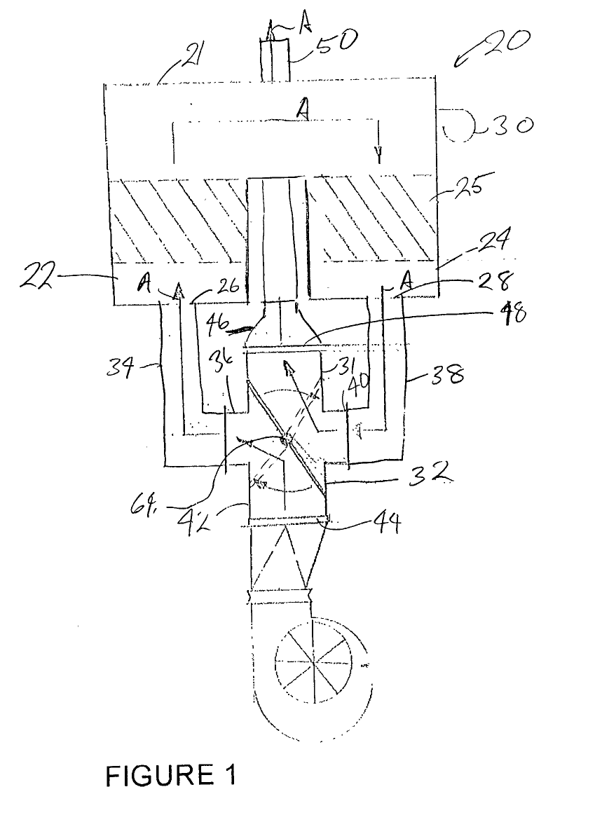

Referring now to FIG. 1 of the drawings, regenerative thermal oxidizer or incinerator 20 is shown diagrammatically having common combustion chamber 21 in flow communication with first and second heat exchangers 22, 24. As will be appreciated by those skilled in the art of regenerative incinerators, heat exchangers 22, 24 define chambers which house a heat exchange element 25 such as ceramic saddles or porous ceramic monoliths. Heat exchanger 22 has inlet/outlet 26 through which gas enters and exits the combustion chamber 21. Similarly, heat exchanger 24 has inlet/outlet 28 which provides flow access. The opposite ends of heat exchangers 22, 24 are attached to combustion chamber 21 in the standard fashion; that is, a flow passage is created by which process gases can flow into one of the heat exchangers, into the combustion chamber (which is equipped with a burner 30) and then out through the opposite heat exchanger. As described in the background section of this application, as the hot combustion gases flow through the exit heat exchanger heat is transferred to the ceramic heat exchange element. The path of gases through heat exchangers 22, 24 and combustion chamber 21 are shown by the arrows marked “A” in FIG. 1 in one mode of operation.

Still referring to FIG. 1 of the drawings, the duct and valve assembly of the invention will now be described. There are essentially four ducts or passages for gas from the heat exchangers to the valve body 31 of valve assembly 32. The first is transfer duct 34 which is in flow communication with heat exchanger 22. Transfer duct 34 extends between heat exchanger 22 and valve port 36. A second transfer duct 38 extends from heat exchanger 24 to port 40 of valve body 31. Inlet or process gas duct 42 extends from the source of process gas (not shown) to process flow inlet 44 of valve body 31. Finally, outlet or exhaust gas duct 46 extends from process flow outlet 48 of valve body 31 to exhaust stack 50.

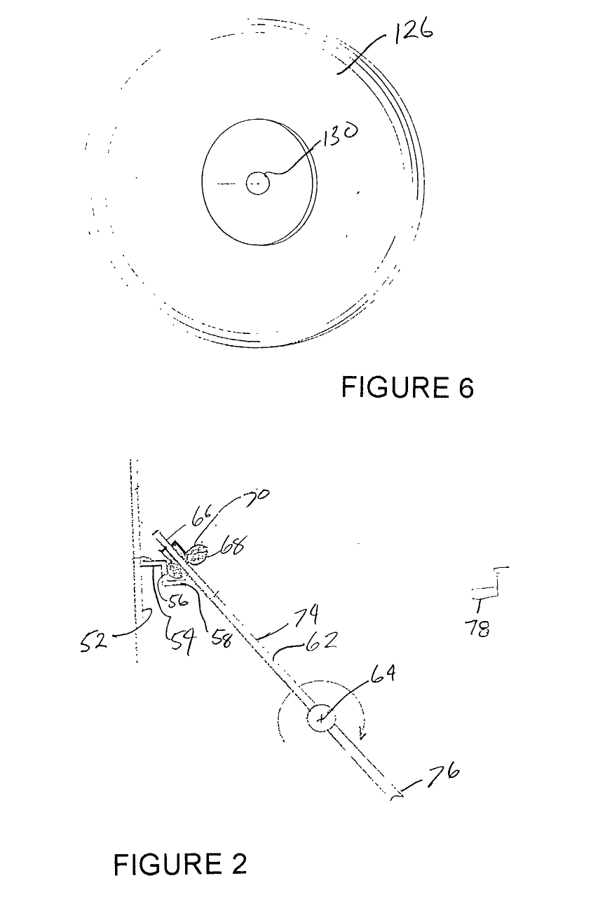

Referring also to FIG. 2, valve body 31 has interior surface 52. Affixed to interior surface 52 is valve seat 54. Valve seat 54 has compound sealing surfaces 56, 58. Pivotally mounted within valve body 31 is disk 62. Disk 62 has a pivotal axis that is generally coterminous with a pivot shaft 64. Disk 62 is elliptical in shape. Disk 62 has an outer perimeter 66. Both sides of the outer perimeter 66 have affixed thereto an elastomeric seal 68. Elastomeric seal 68 has a head 70, typically sized to compress 50% when sealably engaged with sealing surfaces 56, 58.

Disk 62 has a first position as shown in FIG. 1 connecting process inlet 44 with port 36 and inlet 26. Simultaneously, disk 62 connects ports 36, 40 with outlet 48 which connects with exhaust stack 50. In a second position shown in phantom in FIG. 1, disk 62 connects inlet 44 with port 40 and inlet/outlet 28 and additionally, connects inlet/outlet 26 and port 36 with outlet 48 and exhaust stack 50.

Elliptical disk 62 also has an upper conic semi-hemisphere 74 and a lower conic semi-hemisphere 76. Valve seat 54 is formed in a spiral on surface 52 to project a semi-elliptical valve seat surface for disk 62. Additionally, there is provided a valve seat 78 to sealably engage with the seal 68 when disk 62 is in its second position. In a similar manner, two addition valve seats are provided (not shown) for sealably engaging with the lower semi-hemisphere 76 of the disk 62.

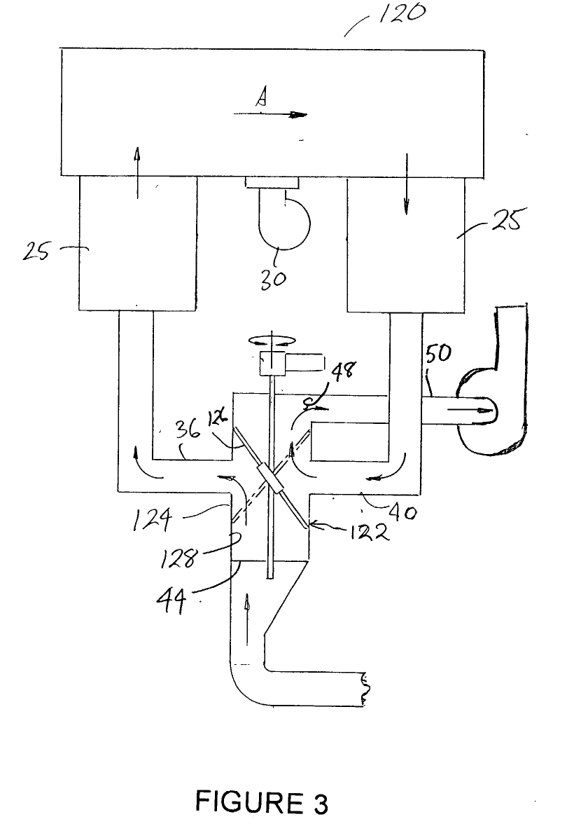

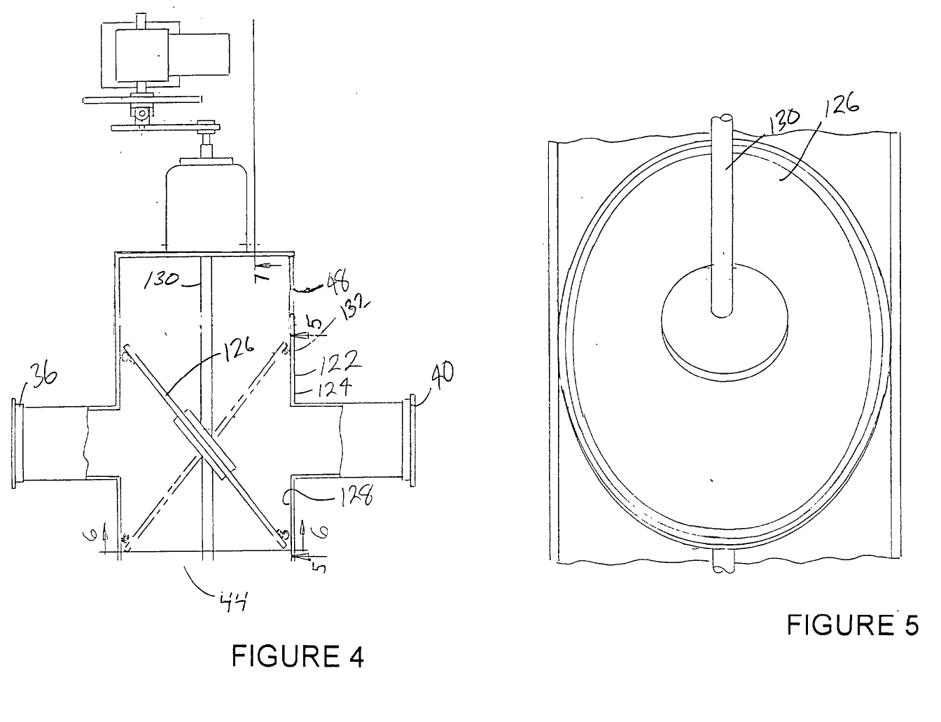

Referring now to FIGS. 3-6, another embodiment RTO 120 is shown with items performing similar functions to those in FIGS. 1 and 2 being given like reference numerals. RTO 120 has a valve assembly 122 and valve body 124. Mounted for pivotal movement within valve body 124 is valve disk 126. Valve disk 126 has a first position sealably engaged with interior surface wall 128 of the valve body wherein process flow inlet 44 is connected with a first port 36. In like manner, process flow outlet 48 is connected with port 40. In a second position shown in phantom, port 36 is connected with outlet 48 and port 40 is connected with inlet 44. Valve disk 126 is connected with a shaft 130 at an angle, typically, 30 degrees to 60 degrees with a plane of extension of valve disk 126. Valve disk 126 has seals 132 that directly sealably engage valve body interior surface 128. Valve disk 126 may be pivoted in a reciprocating manner by a motor and linkage arrangement as shown in FIGS. 4, 7 and 8 and as previously described for valve disk 62. Valve disk 126 may also be pivoted in a constant angular direction by a motor 141 as shown in FIG. 3. Valve disk 126 may also be programmed to pivot unidirectionally or bi-directionally.

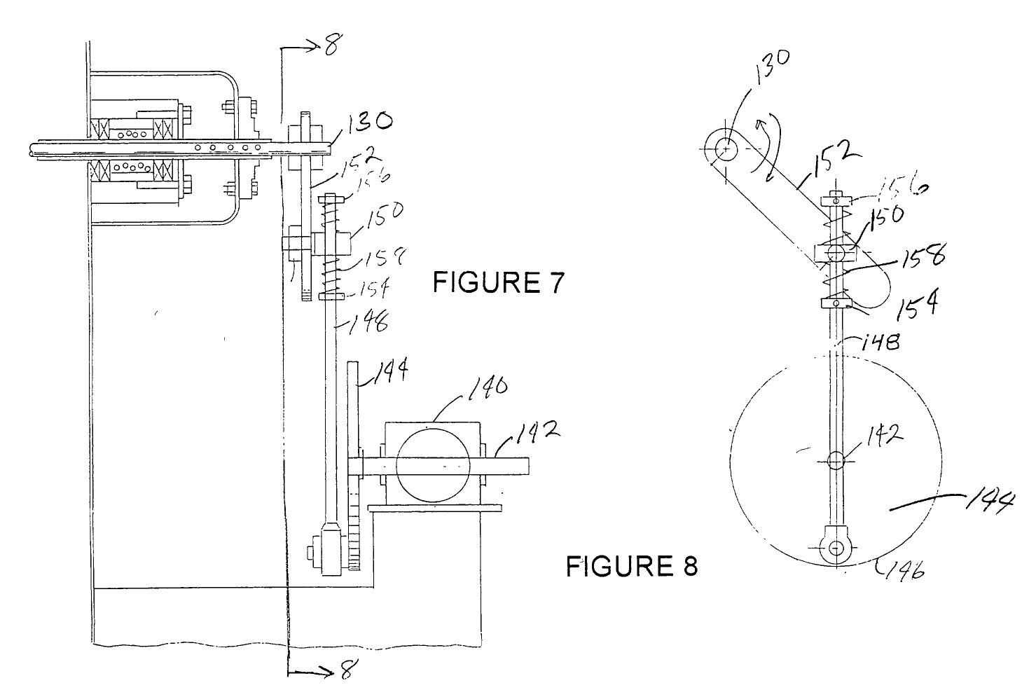

Referring now to FIGS. 7-8, to reciprocally rotate valve disk 62 or 126 there is provided a motor 140. Motor 140 rotates shaft 142. Connected at an end of shaft 142 is a disk 144. Disk 144 adjacent its outer perimeter 146 is pivotally connected with rod 148. Rod 148 opposite its pivotal connection with disk 144 is slidably encircled by pivot washer 150. Pivot washer 150 is pivotally connected with pivot arm 152. Pivot arm 152 is connected with shaft 64 or shaft 130. Positionally locked on rod 148 are set washers 154, 156. Each set washer 154, 156 captures between itself and pivot washer 150 at a spring 158. Springs 158 act as compliance members to absorb shock in the opening and closing of the disk.

While preferred embodiments of the present invention have been disclosed, it is to be understood that they have been disclosed by way of example only and that various modifications can be made without departing from the spirit and scope of the invention as it is explained by the following claims.

I claim:

1. A valve for a regenerative thermal oxidizer comprising:
a cylindrical body having process flow inlet and outlet and first and second side ports; and
an elliptical disk having an outer perimeter for sealably engaging said cylindrical body, said disk being pivotally mounted within said body having a first position connecting said process flow inlet with said first side port and said process flow outlet with said second side port and said disk having a second position connecting said process flow outlet with said first side port and said process flow inlet with said second side port.

2. A valve as described in claim 1, wherein said valve disk has a pivotal axis about a plane of said disk.

3. A valve as described in claim 1, wherein said disk has a pivotal axis at an angle with a plane of said disk.

4. A valve as described in claim 3, wherein said valve pivots in one angular direction.

5. A valve as described in claim 4, wherein said valve can pivot unidirectionally or bi-directionally.

6. A valve as described in claim 4, wherein said elliptical disk seals directly against said valve body wall.

7. A valve as described in claim 1, wherein said disk perimeter has a polymeric seal attached thereto.

8. A valve as described in claim 6, wherein said disk has a seal on both sides of said disk.

9. A valve as described in claim 1, wherein said valve body has mounted within said body a valve seat and said valve seat has a spiral path within said body.

10. A valve as described in claim 7, wherein said body additionally has a spiral seat and said seat has compound sealing surfaces for sealably engaging with said seal on said disk.

11. A valve body as described in claim 1, wherein said disk has a shaft attached thereto and said shaft is connected with a pivot arm which is moved by an electric motor.

12. A valve as described in claim 11, having a compliance member between said motor and said disk.

13. A valve as described in claim 11, wherein said motor has a shaft with a disk connected thereto and said motor disk has a pivotally attached rod connected to said pivot arm and said rod has a linear compliant pivotal connection with said pivot arm.

14. A valve for a regenerative thermal oxidizer comprising:
a cylindrical body having a process flow inlet and outlet and first and second side ports;
an elliptical valve disk having an outer perimeter with an elastomeric seal attached thereto on both sides for sealably engaging said cylindrical body, said disk being pivotally mounted by a shaft within said cylindrical body, said shaft extending in a plane said cylindrical disk and said disk having a first position connecting said process flow inlet with said first port and said process flow outlet with said second port and a second position connecting said process flow outlet with said first port and said process flow inlet with said second port; and
a motor for turning said valve disk within said cylindrical body, said motor being linkably connected with a pivot arm connected with said shaft through a compliant member.

15. A valve for a regenerative thermal oxidizer comprising:
a cylindrical body having a process flow inlet and outlet and first and second side ports;
an elliptical valve disk having an outer perimeter for sealably engaging said cylindrical body, said disk being pivotally mounted within said body by a shaft having an angle with respect to a plane of said disk, said disk having a first position connecting said process flow inlet with said first port and said process flow outlet with said second port and a second position connecting said process flow outlet with said first port and said process flow inlet with said second port; and
a motor for pivoting said disk in one angular direction.

16. A regenerative thermal oxidizer comprising:
a first heat exchanger defining a first flow path;
a first inlet/outlet in association with said first heat exchanger, said first inlet/outlet providing flow access to said first flow path;
a second heat exchanger defining a second flow path;
a second inlet/outlet in association with said second heat exchanger, said second inlet/outlet providing flow access to said second flow path;
a valve assembly having a cylindrical valve body having process flow inlet and outlet and first and second ports connected with respect to first and second inlet/outlet in said heat exchangers; and
said valve assembly having an elliptical valve disk having an outer perimeter for sealably engaging said cylindrical body, said disk being pivotally mounted within said body having a first position connecting said process flow inlet with said first port and said process flow outlet with said second port and said disk having a second position connecting said process flow outlet with said first port and said process flow inlet to said second port.

17. A regenerative thermal oxidizer as described in claim 16, wherein said valve disk has a pivotal axis about a plane of said disk.

18. A regenerative thermal oxidizer as described in claim 16, wherein said disk has a pivotal axis at an angle with a plane of said disk.

19. A regenerative thermal oxidizer as described in claim 18, wherein said valve pivots in one angular direction.

20. A regenerative thermal oxidizer as described in claim 16, wherein said disk perimeter has a polymeric seal attached thereto.

21. A regenerative thermal oxidizer as described in claim 16, wherein said valve body has mounted within said body a valve seat and said valve seat has a spiral path within said body.

22. A regenerative thermal oxidizer as described in claim 20, wherein said disk has a seal on both sides of said disk.

23. A regenerative thermal oxidizer as described in claim 19, wherein said elliptical disk seals directly against said valve body wall.

24. A regenerative thermal oxidizer as described in claim 20, wherein said body additionally has a spiral seat and said seat has compound sealing surfaces for sealably engaging with said seal on said disk.

25. A regenerative thermal oxidizer body as described in claim 16, wherein said disk has a shaft attached thereto and said shaft is connected with a pivot arm which is moved by an electric motor.

26. A regenerative thermal oxidizer as described in claim 25, having a compliance member between said motor and said disk.

27. A regenerative thermal oxidizer as described in claim 25, wherein said motor has a shaft with a disk connected thereto and said motor disk has a pivotally attached rod connected to said pivot arm and said rod has a linear compliant pivotal connection with said pivot arm.
